(19) United States
(12) Patent Application Publication
(10) Pub. No.: US 2024/0353542 A1
(43) Pub. Date: Oct. 24, 2024

(54) RANGING DEVICE

(71) Applicant: CANON KABUSHIKI KAISHA, Tokyo (JP)

(72) Inventor: SATOSHI OMODANI, Tokyo (JP)

(21) Appl. No.: 18/635,351

(22) Filed: Apr. 15, 2024

(30) Foreign Application Priority Data
Apr. 19, 2023 (JP) 2023-068362

(51) Int. Cl. G01S 7/487; G01S 7/484; G01S 7/4863

(52) U.S. Cl. CPC G01S 7/4876; G01S 7/484; G01S 7/4863

(57) ABSTRACT

A ranging device including: a control unit controlling a timing at which a light source device emits pulsed light; a light receiving unit including a pixel; and a ranging unit acquiring information indicating a distance to an object based on signals acquired while shifting a period in which signal generation is performed in the light receiving unit. The pixel includes a first holding unit and a second holding unit that hold signals indicating a presence or absence of incidence of the pulsed light on the pixel in a first period and a second period, respectively. The control unit performs control so that first pulsed light and second pulsed light are emitted at different times in one signal acquisition period. A time difference between the first period and the second period is set to correspond to a time difference between the first pulsed light and the second pulsed light.

### BACKGROUND

### Field

The present invention relates to a ranging device.

### Description of the Related Art

U.S. Patent Application Publication No. 2017/0052065 discloses a ranging device that measures a distance to an object by emitting light from a light source and receiving light including reflected light from the object by a light receiving element. In addition, U.S. Patent Application Publication No. 2017/0052065 discloses a method of repeatedly performing measurement while changing a gating period in which detection of photons is performed in a light receiving element.

Japanese Patent Application Laid-Open No. 2019-078602 discloses a ranging device including a light source that outputs a plurality of rays of pulsed light at predetermined time intervals. As the ranging device, a ranging device capable of performing longer distance measurement for an object by increasing an intensity of a signal component in a reflected pulse train is described.

In the ranging devices as described in U.S. Patent Application Publication No. 2017/0052065 and Japanese Patent Application Laid-Open No. 2019-078602, ranging accuracy may be deteriorated due to noise such as disturbance light from a light source other than a ranging light source.

### SUMMARY

An object of the present invention is to provide a ranging device capable of reducing deterioration in ranging accuracy caused by noise.

According to a disclosure of the present specification, there is provided a ranging device including: a control unit configured to control a timing at which a light source device emits pulsed light; a light receiving unit that includes a pixel configured to generate a signal indicating a presence or absence of incidence of light in some of a plurality of periods corresponding to a time from emission to reception of the pulsed light; and a ranging unit configured to acquire information indicating a distance to an object based on a plurality of signals acquired while shifting a period in which signal generation is performed in the light receiving unit. The pixel includes a first holding unit configured to hold a signal indicating a presence or absence of incidence of the pulsed light on the pixel in a first period, and a second holding unit configured to hold a signal indicating a presence or absence of incidence of the pulsed light on the pixel in a second period different from the first period. The control unit performs control so that first pulsed light and second pulsed light are emitted at different times in one signal acquisition period. A time difference between the first period and the second period is set to correspond to a time difference between the first pulsed light and the second pulsed light. The ranging unit performs ranging based on the signal held in the first holding unit and the signal held in the second holding unit.

Further features of the present invention will become apparent from the following description of exemplary embodiments with reference to the attached drawings.

### BRIEF DESCRIPTION OF THE DRAWINGS

FIG. 1 is a block diagram illustrating a schematic configuration of a ranging device according to a first embodiment.

FIG. 2 is a block diagram illustrating a configuration of a light receiving unit according to the first embodiment.

FIG. 3 is a block diagram illustrating a configuration of a pixel according to the first embodiment.

FIG. 4 is a timing chart illustrating timings of emitted light, reflected light, and a gate signal according to the first embodiment.

FIGS. 5A and 5B illustrate examples of histograms illustrating a frequency distribution of a photon count value at each gate shift position according to the first embodiment.

FIG. 6 is a flowchart illustrating a distance calculation method in a ranging unit according to the first embodiment.

FIG. 7 is a flowchart illustrating a distance calculation method in a ranging unit according to a second embodiment.

FIG. 8 is a block diagram illustrating a configuration of a pixel according to a third embodiment.

FIG. 9 illustrates an example of a histogram illustrating a frequency distribution of a photon count value at each gate shift position according to the third embodiment.

FIGS. 10A and 10B are block diagrams illustrating a configuration of a pixel according to a fourth embodiment.

FIGS. 11A and 11B are timing diagrams illustrating timings of emitted light, reflected light, and a gate signal according to the fourth embodiment.

FIGS. 12A and 12B are block diagrams illustrating a configuration of a pixel according to a fifth embodiment.

FIGS. 13A and 13B are schematic diagrams of equipment according to a sixth embodiment.

### DESCRIPTION OF THE EMBODIMENTS

Hereinafter, embodiments of the present invention will be described with reference to the drawings. Identical or corresponding elements are denoted by common reference numerals throughout the drawings, and a description thereof may be omitted or simplified.

### First Embodiment

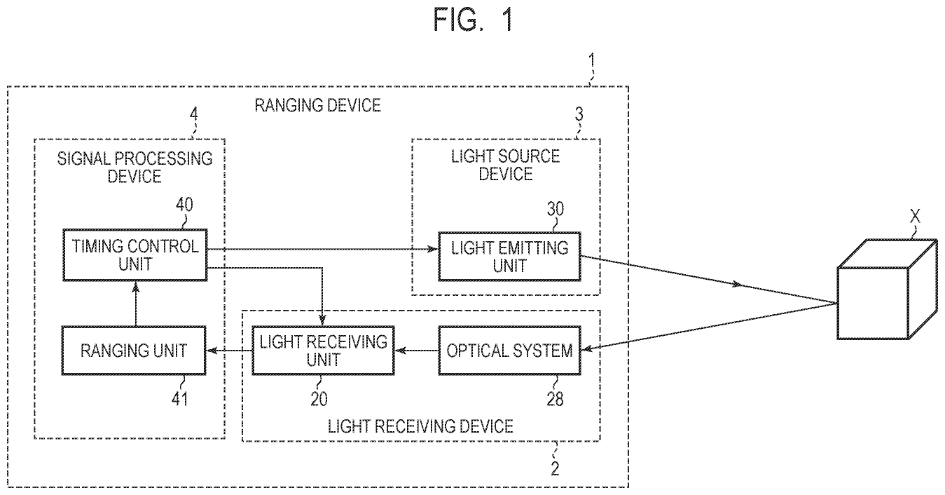

FIG. 1 is a block diagram illustrating a schematic configuration of a ranging device 1 according to a first embodiment. As illustrated in FIG. 1, the ranging device 1 includes a light receiving device 2, a light source device 3, and a signal processing device 4. The light receiving device 2 includes a light receiving unit 20 and an optical system 28. The light source device 3 includes a light emitting unit 30. The signal processing device 4 includes a timing control unit 40 and a ranging unit 41. The configuration of the ranging device 1 illustrated in the present embodiment is an example, and the configuration of the ranging device 1 is not limited to the illustrated configuration. For example, the light source device 3 may be disposed outside the ranging device 1. Also in this case, the light emitting unit 30 operates in accordance with a control signal from the timing control unit 40 (control unit).

The ranging device 1 is a device that measures a distance to an object X for which ranging is to be performed by using a technology such as light detection and ranging (LiDAR). The ranging device 1 measures the distance from the ranging device 1 to the object X based on a time difference from when light emitted from the light source device 3 is reflected by the object X to when the reflected light is received by the light receiving device 2. In addition, the ranging device 1 can two-dimensionally measure distances to a plurality of points by emitting laser light to a predetermined ranging range including the object X and receiving reflected light by a pixel array. As a result, the ranging device 1 can generate and output a distance image. Such a method may be referred to as Flash LiDAR.

The light received by the light receiving device 2 includes ambient light such as sunlight, disturbance light from another light source, and the like in addition to the reflected light from the object X. Therefore, the ranging device 1 generates a frequency distribution obtained by counting incident light in each of a plurality of periods (bin periods), and performs ranging in which an influence of the ambient light or the like is reduced using a method of determining that the reflected light is incident in a period in which a light quantity is at the peak.

The signal processing device 4 may include a processor that performs arithmetic processing of a digital signal, a memory that stores a digital signal, a control circuit that controls operations of the light receiving device 2 and the light source device 3, and the like. The timing control unit 40 outputs a control signal for controlling a light emission timing of the light emitting unit 30 and a control signal for controlling an exposure timing of the light receiving unit 20.

The light source device 3 is a device that emits light such as laser light to the outside of the ranging device 1. The light emitting unit 30 of the light source device 3 includes, for example, a semiconductor laser diode as a light source. The light emitting unit 30 emits laser light having a predetermined pulse width based on the control signal from the timing control unit 40. The laser light is diffused through an optical system such as a diffusion plate and is radiated to a predetermined two-dimensional range. The light source device 3 according to the present embodiment emits pulsed light including at least two pulses separated by a predetermined time difference T1 within one minimum ranging operation unit period based on the control signal from the timing control unit 40.

The optical system 28 includes an optical element such as a lens that forms an image of incident light on the light receiving unit 20. The reflected light generated by reflection of the laser light emitted from the light emitting unit 30 by the object X forms an image on the light receiving unit 20 via the optical system 28.

The light receiving unit 20 is, for example, a photoelectric conversion device including an avalanche photodiode (hereinafter, referred to as APD) as a photoelectric conversion element. In this case, when one photon enters the APD and charges are generated, one pulse is generated by avalanche multiplication. However, the light receiving unit 20 may also use, for example, a photoelectric conversion element using another photodiode.

The ranging unit 41 generates information indicating the distance from the ranging device 1 to the object X based on an electric signal output from the light receiving unit 20. Furthermore, the ranging unit 41 outputs a control signal necessary for ranging control to the timing control unit 40.

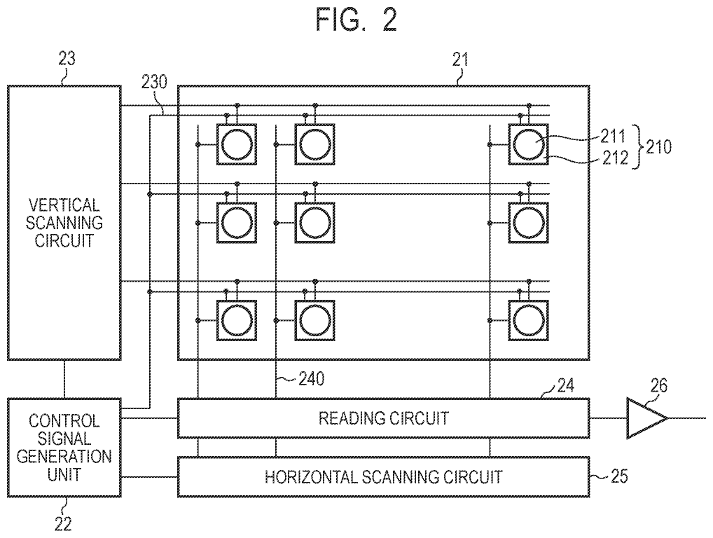

FIG. 2 is a block diagram illustrating a configuration of the light receiving unit 20 according to the first embodiment. The light receiving unit 20 includes a pixel array 21, a control signal generation unit 22, a vertical scanning circuit 23, a reading circuit 24, a horizontal scanning circuit 25, and an output circuit 26.

In the pixel array 21, a plurality of pixels 210 are arranged in a plurality of rows and a plurality of columns. Each of the plurality of pixels 210 includes a photoelectric conversion unit 211 including a photoelectric conversion element, and a pixel circuit 212. The photoelectric conversion unit 211 converts incident light into an electric signal. A signal output from the photoelectric conversion unit 211 of each pixel 210 is processed in the pixel circuit 212. The pixel circuit 212 includes at least one of a counter circuit or a memory. The pixel circuit 212 outputs the processed digital signal to the reading circuit 24 via a signal line 240 arranged for each column of the pixel array 21.

The vertical scanning circuit 23 supplies a control signal to each of the plurality of pixel circuits 212 based on a control signal supplied from the control signal generation unit 22. The vertical scanning circuit 23 supplies a control signal for each row to each pixel circuit 212 via a drive line provided for each row of the pixel array 21. A logic circuit such as a shift register or an address decoder can be used as the vertical scanning circuit 23. As a result, the vertical scanning circuit 23 selects a row for outputting a signal from the pixel circuit 212 to the reading circuit 24.

The horizontal scanning circuit 25 supplies a control signal to the reading circuit 24 based on a control signal supplied from the control signal generation unit 22. In order to read a signal from each pixel circuit 212 holding a digital signal, the reading circuit 24 outputs a control signal for sequentially selecting each column to the pixel circuit 212. A digital signal generated in the pixel circuit 212 of the pixel 210 selected by the vertical scanning circuit 23 and the horizontal scanning circuit 25 is output to the ranging unit 41 via the reading circuit 24 and the output circuit 26.

The control signal generation unit 22 outputs a control signal to the pixel circuit 212 via a pixel control signal line 230. The pixel control signal line 230 is connected to all the pixel circuits 212, and the control signal is common to all the pixel circuits 212.

In FIG. 2, the plurality of pixels 210 are two-dimensionally arranged in the pixel array 21, but the present invention is not limited thereto. For example, the arrangement of the plurality of pixels 210 may be one-dimensional. Furthermore, only a single pixel 210 may be arranged in the light receiving unit 20.

Furthermore, a function of the pixel circuit 212 does not have to be necessarily provided for every pixel 210. For example, one pixel circuit 212 may be shared by the plurality of pixels 210. In this case, the pixel circuit 212 sequentially processes signals output from a plurality of photoelectric conversion units 211, thereby providing a signal processing function to the plurality of pixels 210.

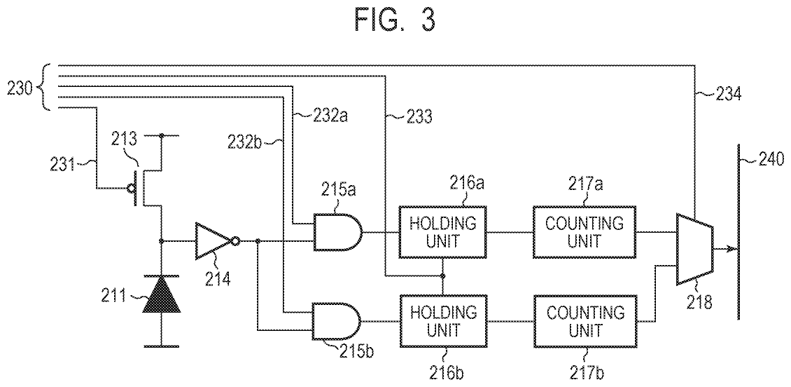

FIG. 3 is a block diagram illustrating a configuration of the pixel 210 according to the present embodiment. The pixel 210 includes a photoelectric conversion unit 211, a quenching element 213, a waveform shaping unit 214, gate elements 215a and 215b, holding units 216a and 216b, counting units 217a and 217b, and a selector element 218. The quenching element 213, the waveform shaping unit 214, the gate elements 215a and 215b, the holding units 216a and 216b, the counting units 217a and 217b, and the selector element 218 correspond to the pixel circuit 212 in FIG. 2. In the following description, the photoelectric conversion unit 211 is assumed to be an APD having an anode and a cathode. In addition, the quenching element 213 is assumed to be a PMOS transistor. Furthermore, the pixel control signal line 230 of FIG. 2 includes five pixel control signal lines 231, 232a, 232b, 233, and 234.

The APD 211 generates a charge pair corresponding to incident light by photoelectric conversion. A potential VL is supplied to the anode of the APD 211. In addition, the cathode of the APD 211 is connected to a drain of the quenching element 213 and an input terminal of the waveform shaping unit 214. A potential VH higher than the potential VL is supplied to a source of the quenching element 213, and a potential higher than the potential VL supplied to the anode is supplied to the cathode of the APD 211. In this manner, a potential is supplied to the anode and the cathode of the APD 211 to apply a reverse bias voltage in such a way that a photon incident on the APD 211 is subjected to avalanche multiplication. In the APD 201 to which the reverse bias voltage is supplied, when a charge is generated by incident light, the charge causes avalanche multiplication, and an avalanche current is generated.

Operation modes in a case where the reverse bias voltage is supplied to the APD 211 include a Geiger mode and a linear mode. The Geiger mode is a mode in which the anode and the cathode are operated at a potential difference higher than a breakdown voltage, and the linear mode is a mode in which the anode and the cathode are operated at a potential difference close to or lower than the breakdown voltage. The APD 211 may be operated in the Geiger mode or may be operated in the linear mode. The APD operated in the Geiger mode is referred to as a single photon avalanche diode (SPAD). Using the SPAD is desirable because a weak signal at a single photon level can be detected at a high speed.

The quenching element 213 has a function of replacing a change in avalanche current generated in the APD 211 with a potential signal. When a photocurrent is subjected to avalanche multiplication in the APD 211, a current obtained by the multiplied charge flows to a connection node between the APD 211 and the quenching element 213. The potential of the cathode of the APD 211 decreases, and electron avalanche does not occur in the APD 211 due to a voltage drop caused by the current. As a result, the avalanche multiplication in the APD 211 stops.

The pixel control signal line 231 is connected to a gate of the quenching element 213. The control signal generation unit 22 supplies a recharge signal to the gate of the quenching element 213 via the pixel control signal line 231. When the recharge signal becomes a low level, a potential corresponding to the potential VH is supplied to the cathode of the APD 211 via the quenching element 213. As a result, the APD 211 returns to a state in which avalanche multiplication is possible again.

As described above, the quenching element 213 functions as a load circuit at the time of charge multiplication by avalanche multiplication, and suppresses avalanche multiplication (quenching operation). In addition, the quenching element 213 returns the APD 211 to a state in which avalanche multiplication is possible again after the avalanche multiplication is suppressed (recharge operation).

The waveform shaping unit 214 shapes a potential change of the cathode of the APD 211 obtained at the time of photon detection, and outputs a high-level pulse signal. For example, an inverter circuit is used as the waveform shaping unit 214. Although FIG. 3 illustrates an example in which one inverter is used as the waveform shaping unit 214, a circuit in which a plurality of inverters are connected in series, or another circuit having a waveform shaping effect may be used as the waveform shaping unit 214.

The gate elements 215a and 215b are logic circuits that perform gating in such a way as to pass the pulse signal output from the waveform shaping unit 214 for a predetermined period. FIG. 3 illustrates an example using AND circuits each having two input terminals as the gate elements 215a and 215b. An output terminal of the waveform shaping unit 214 is connected to a first input terminal of the gate element 215a and a first input terminal of the gate element 215b. The pixel control signal line 232a is connected to a second input terminal of the gate element 215a, and the pixel control signal line 232b is connected to a second input terminal of the gate element 215b. The control signal generation unit 22 supplies gate signals Pga and Pgb to the gate elements 215a and 215b via the pixel control signal lines 232a and 232b, respectively.

The gate elements 215a and 215b output logical products of the gate signals Pga and Pgb and an output signal of waveform shaping unit 214 to the holding units 216a and 216b, respectively. Consequently, the gate elements 215a and 215b allow the output signal of the waveform shaping unit 214 to pass during a period (exposure period) in which the gate signals Pga and Pgb are at a high level. The exposure period means a period in which a high-level pulse signal output from the waveform shaping unit 214 can pass through the gate elements 215a and 215b and reach the holding units 216a and 216b when the APD 211 detects a photon. In other words, the exposure period is a period in which counting of photons incident on the APD 211 is enabled. Since the different gate signals Pga and Pgb are input to the gate elements 215a and 215b, the exposure periods for the gate elements 215a and 215b can be set to different periods. The gate elements 215a and 215b only need to implement gating, and may have a circuit configuration other than the AND circuit. In addition, the waveform shaping unit 214 and the gate elements 215a and 215b may be integrated by using a logic circuit such as a NAND circuit.

Each of the holding units 216a and 216b is a circuit having a storage capacity for holding a 1-bit signal. In a case where a high-level pulse signal is input from the gate element 215a, the holding unit 216a (first holding unit) holds a 1-bit signal (high-level signal) indicating that the pulse signal is input. Similarly, in a case where a high-level pulse signal is input from the gate element 215b, the holding unit 216b (second holding unit) holds a 1-bit signal (high-level signal) indicating that the pulse signal is input. That is, the 1-bit signals are signals indicating the presence or absence of incidence of pulsed light.

The pixel control signal line 233 is connected to reset terminals of the holding units 216a and 216b. The control signal generation unit 22 supplies a holding unit reset signal to the holding units 216a and 216b via the pixel control signal line 233. The holding unit 216a outputs a 1-bit signal to the counting unit 217a (first counting unit), and the holding unit 216b outputs a 1-bit signal to the counting unit 217b (second counting unit). Thereafter, the holding units 216a and 216b reset the held 1-bit signals based on the holding unit reset signal.

The holding units 216a and 216b are, for example, RS-flip-flops. The counting units 217a and 217b are counters that store a multi-bit digital signal (count value) to be counted up according to an edge of an input signal. The counting units 217a and 217b may be capable of resetting the count value according to the control signal from the control signal generation unit 22. Once the resetting is performed, the counting units 217a and 217b discard the existing count value and newly start counting up. The counting units 217a and 217b may or do not have to be arranged in each of the plurality of pixels 210 as illustrated in FIG. 3. For example, the counting units 217a and 217b may be arranged in the reading circuit 24. In this case, the counting units 217a and 217b may be shared by the plurality of pixels 210.

Output terminals of the counting units 217a and 217b are connected to two input terminals of the selector element 218. The pixel control signal line 234 is connected to a control terminal of the selector element 218. The control signal generation unit 22 supplies a selection signal to the selector element 218 via the pixel control signal line 234. The selector element 218 sequentially connects the two input terminals to the signal line 240 according to the selection signal. As a result, the selector element 218 sequentially outputs the signals held in the counting units 217a and 217b to the signal line 240. The number of signal lines 240 may correspond to the number of bits of the count value held in each of the counting units 217a and 217b.

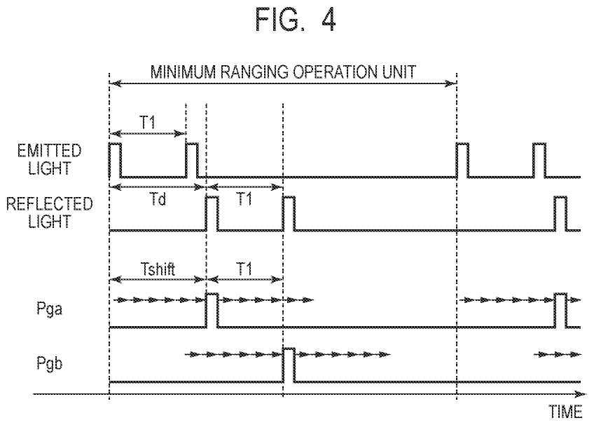

FIG. 4 is a timing chart illustrating timings of the emitted light, the reflected light, and the gate signals Pga and Pgb according to the present embodiment. The ranging device 1 according to the present embodiment is a ranging device of a time-gated time-of-flight (ToF) method. In the time-gated ToF method, repetitive signal acquisition is performed while shifting (gate shift) a length of a time from the light emission timing to the start of the exposure period (a time of flight of the emitted light). Then, a frequency distribution is generated from obtained frequencies of photon counts of a plurality of frames, and a time of flight of light corresponding to a period (bin) with a peak frequency is converted into a distance, thereby calculating the distance between the ranging device 1 and the object X. FIG. 4 illustrates an operation timing in the minimum ranging operation unit. The minimum ranging operation unit is one signal acquisition period including one set of light emission including a plurality of rays of pulsed light and reception of reflected light thereof.

“Emitted light” in FIG. 4 indicates the light emission timing of the light emitting unit 30. “Reflected light” in FIG. 4 indicates a timing of a pulse signal generated when a photon is incident on the light receiving unit 20. “Pga” and “Pgb” in FIG. 4 indicate timings of changes in levels of the gate signals Pga and Pgb, respectively. Arrowed symbols in “Pga” and “Pgb” in FIG. 4 schematically indicate changes in exposure period due to the gate shift.

As illustrated in FIG. 4, in the minimum ranging operation unit period, the light emitting unit 30 emits two rays of pulsed light at an interval of a predetermined time difference T1 under the control of the timing control unit 40. In other words, the light emitting unit 30 emits first pulsed light and second pulsed light at different times, and a time difference between a light emission time of the first pulsed light and a light emission time of the second pulsed light is T1. The emitted pulsed light is reflected by the object X, and the reflected light reaches the light receiving unit 20 at the time when a time Td of flight of the light has elapsed from the emission time. The time difference T1 between the two rays of pulsed lights is maintained also for the reflected light.

A period in which the gate signal Pga is at the high level is an exposure period (first period) during which holding of a signal in the holding unit 216a and counting in the counting unit 217a are enabled. A period in which the gate signal Pgb is at a high level is an exposure period (second period) in which holding of a signal in the holding unit 216b and counting in the counting unit 217b are enabled. That is, in the present embodiment, two exposure periods during which signals can be held in the holding units 216a and 216b are set in the minimum ranging operation unit period. The period in which the gate signal Pga is at a high level is earlier than the period in which the gate signal Pgb is at the high level. A time difference Tshift from the first light emission to when the gate signal Pga becomes a high level is changed (gate shift) by the timing control unit 40 every minimum ranging operation unit or every time a plurality of minimum ranging operation units elapse. A timing at which the gate signal Pgb becomes a high level is controlled in such a way that a time difference from a timing at which the gate signal Pga becomes a high level becomes T1 regardless of the amount of gate shift. That is, a time difference between the gate signal Pga and the gate signal Pgb coincides with a time difference between the two rays of pulsed light.

FIG. 4 illustrates the high-level periods of the gate signals Pga and Pgb as an example of a case where the time of flight Td of the light and the time difference Tshift become closest due to the gate shift. The high-level period of the gate signal Pga substantially coincides with a pulse of the first reflected light. Therefore, the holding unit 216a holds a signal based on the first reflected light. The high-level period of the gate signal Pgb substantially coincides with a pulse of the second reflected light. Therefore, the holding unit 216b holds a signal based on the second reflected light. In the minimum ranging operation unit period illustrated in FIG. 4, the count values held in the counting units 217a and 217b are counted up by 1.

In a case where the time difference Tshift is different from the minimum ranging operation unit illustrated in FIG. 4 due to the gate shift, the time of flight Td of the light does not coincide with the time difference Tshift. In this case, the signals based on the reflected light do not reach the holding units 216a and 216b, and the count values held in the counting units 217a and 217b are not counted up.

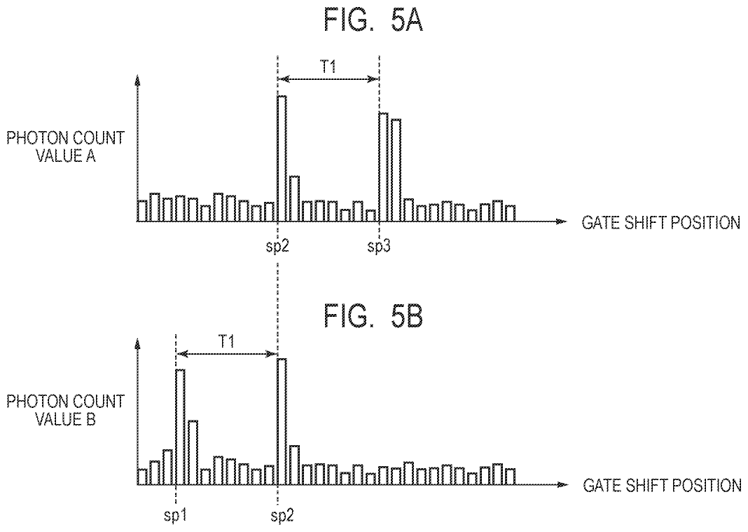

FIGS. 5A and 5B illustrate examples of histograms illustrating a frequency distribution of a photon count value at each gate shift position according to the present embodiment. FIG. 5A illustrates the count value (photon count value A) held in the counting unit 217a at each gate shift position, and FIG. 5B illustrates the count value (photon count value B) held in the counting unit 217b at each gate shift position. The light receiving unit 20 repeatedly performs a minimum ranging operation unit operation for one gate shift position a plurality of times while changing the time difference Tshift (gate shift position) by the gate shift. The counting units 217a and 217b output the photon count value A and the photon count value B counted at each gate shift position to the ranging unit 41. As a result, the ranging unit 41 acquires frequency distribution information as illustrated in FIGS. 5A and 5B.

As illustrated in FIG. 5B, the high photon count value B is obtained at a gate shift position sp1. This is because an incident timing of the reflected light of the first light emission coincides with the high-level period of the gate signal Pgb.

As illustrated in FIGS. 5A and 5B, the high photon count values A and B are obtained at a gate shift position sp2. This is because the incident timing of the reflected light of the first light emission coincides with the high-level period of the gate signal Pga, and an incident timing of the reflected light of the second light emission coincides with the high-level period of the gate signal Pgb. The timing diagram of FIG. 4 illustrates a state corresponding to the gate shift position sp2. Since an interval T1 between a time when the gate signal Pga becomes a high level and a time when the gate signal Pgb becomes a high level is the same as the time difference T1 between the two rays of pulsed light, the photon count value A and the photon count value B peak at the same gate shift position.

As illustrated in FIG. 5A, the high photon count value A is obtained at a gate shift position sp3. This is because the incident timing of the reflected light of the second light emission coincides with the high-level period of the gate signal Pga.

As illustrated in FIGS. 5A and 5B, the photon count value A and the photon count value B are relatively low except for at the gate shift positions sp1, sp2, and sp3 described above. The count values are caused by slight incident light caused by disturbance light and noise occurring at a low frequency in the APD 211, and are not caused by the reflected light from the object X.

As described above, the peaks of each of the photon count value A and the photon count value B are detected at the gate shift positions corresponding to the times of flight of the two rays of pulsed light. One of the two peaks of each of the photon count value A and the photon count value B is detected at the same gate shift position sp2. The ranging unit 41 can calculate the distance from the ranging device 1 to the object X based on the peaks.

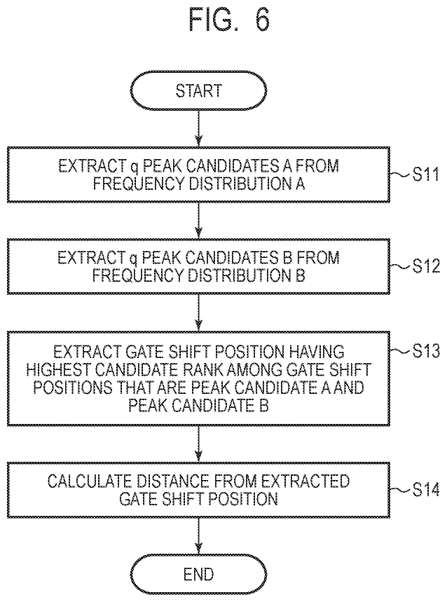

FIG. 6 is a flowchart illustrating a distance calculation method in the ranging unit 41 according to the present embodiment. An example of a distance calculation method in the ranging unit 41 will be described with reference to FIG. 6. In the following description, a frequency distribution of the photon count value A illustrated in FIG. 5A is referred to as a frequency distribution A (first frequency distribution), and a frequency distribution of the photon count value B illustrated in FIG. 5B is referred to as a frequency distribution B (second frequency distribution).

In step S11, the ranging unit 41 extracts q peaks in descending order of the photon count value A from the frequency distribution A. The q peaks extracted by this processing are referred to as peak candidates A. Candidate ranks are set for the q peaks included in the peak candidates A in the order of the magnitude of the photon count value A. Note that q is an integer of 2 or more and is a predetermined value.

In step S12, the ranging unit 41 extracts q peaks in descending order of the photon count value B from the frequency distribution B. The q peaks extracted by this processing are referred to as peak candidates B. Candidate ranks are set for the q peaks included in the peak candidates B in the order of the magnitude of the photon count value B.

In step S13, the ranging unit 41 extracts a gate shift position having the highest candidate rank among the gate shift positions that are the peak candidate A and the peak candidate B.

In step S14, the ranging unit 41 calculates a distance from the time of flight and the speed of light corresponding to the extracted gate shift position. The ranging unit 41 stores the distance obtained by this processing as a distance in the processing target pixel 210. The ranging unit 41 can acquire a two-dimensional distance image by performing a series of distance calculation processing for each pixel.

As described above, the ranging device 1 according to the present embodiment emits two rays of pulsed light at predetermined time intervals in the minimum ranging operation unit, and performs exposure twice by using the two holding units 216a and 216b at the predetermined time intervals. As a result, the ranging can be performed by distinguishing a peak of the frequency distribution caused by noise such as disturbance light and a peak of the frequency distribution caused by the reflected light from the object X. Therefore, according to the present embodiment, the ranging device 1 capable of reducing deterioration in ranging accuracy caused by noise is provided.

As described above, the 1-bit signals held in the holding units 216a and 216b are reset based on the holding unit reset signal. The resetting may be performed every time one minimum ranging operation unit elapses, or may be performed every time a plurality of minimum ranging operation units of a predetermined number of times elapse. By performing the resetting every time one minimum ranging operation unit elapses, signal acquisition is speeded up. By performing the resetting every time a plurality of minimum ranging operation units elapse, if a photon can be detected in at least one of the plurality of minimum ranging operation units, the 1-bit signals are held in the holding units 216a and 216b. Therefore, it is possible to improve a probability that a photon can be detected even in a ranging environment in which an arrival probability of a photon derived from reflected light is low.

### Second Embodiment

In the present embodiment, a modification of the distance calculation method of the first embodiment will be described. In the present embodiment, a description of elements common to the first embodiment may be omitted or simplified.

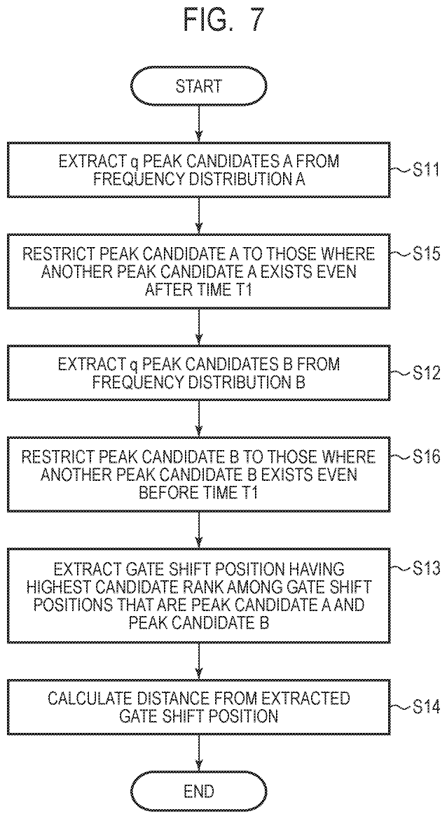

FIG. 7 is a flowchart illustrating a distance calculation method in a ranging unit 41 according to the present embodiment. An example of the distance calculation method in the ranging unit 41 will be described with reference to FIG. 7.

Since an operation of step S11 is similar to that of FIG. 6, a description thereof will be omitted. In step S15, one of peak candidates A where another peak candidate A exists even after a time T1 is extracted from the peak candidates A, and the peak candidate A is restricted thereto.

Since an operation of step S12 is similar to that of FIG. 6, a description thereof will be omitted. In step S16, one of peak candidates B where another peak candidate B exists even before the time T1 is extracted from the peak candidates B, and the peak candidate B is restricted thereto. Since the operations of steps S13 and S14 are similar to those of FIG. 6, a description thereof will be omitted.

As illustrated in FIGS. 5A and 5B, a time difference between gate shift positions sp1 and sp2 is the time T1, and a time difference between gate shift positions sp2 and sp3 is also the time T1. The times T1 are known because they are the same as a time difference T1 of pulsed light. Therefore, by extracting a set of peaks having the time difference T1 from among the peak candidates by the processing of steps S15 and S16, the number of peak candidates A and B can be narrowed down. As a result, an influence of noise such as disturbance light can be further reduced.

Therefore, according to the present embodiment, the ranging device 1 capable of further reducing deterioration in ranging accuracy caused by noise is provided.

### Third Embodiment

In the present embodiment, a modification of the configuration of the pixel 210 according to the first embodiment will be described. In the present embodiment, a description of elements common to the first embodiment or the second embodiment may be omitted or simplified.

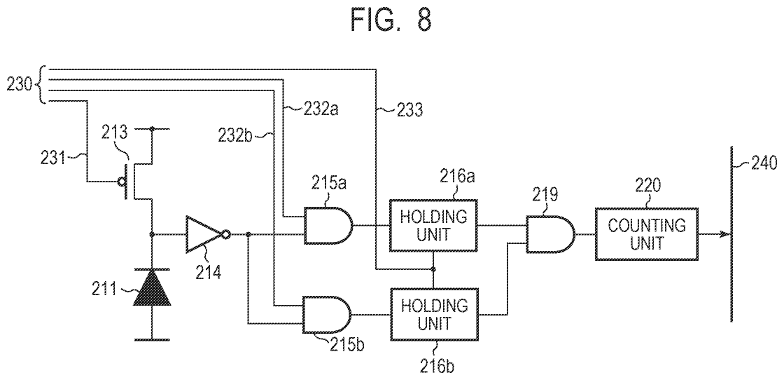

FIG. 8 is a block diagram illustrating a configuration of a pixel 210 according to the present embodiment. In the pixel 210 according to the present embodiment, a gate element 219 and a counting unit 220 are arranged instead of the counting units 217a and 217b and the selector element 218 according to the first embodiment. FIG. 8 illustrates an example in which an AND circuit having two input terminals is used as the gate element 219. An output terminal of a holding unit 216a is connected to a first input terminal of the gate element 219, and an output terminal of the holding unit 216b is connected to a second input terminal of the gate element 219. The gate element 219 outputs a logical product of an output signal of the holding unit 216a and an output signal of the holding unit 216b to the counting unit 220. The counting unit 220 (third counting unit) is a counter that stores a multi-bit digital signal (count value) to be counted up according to an edge of an output signal of the gate element 219. The count value held in the counting unit 220 is output to a signal line 240.

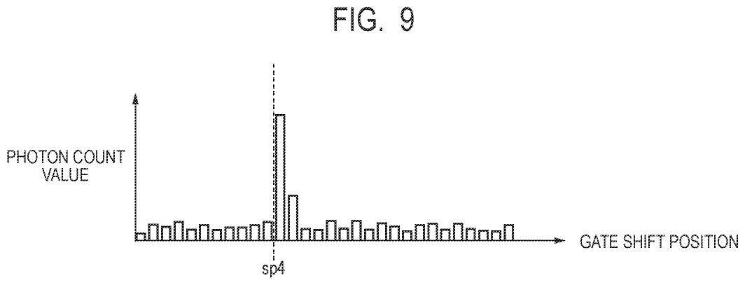

FIG. 9 illustrates an example of a histogram illustrating a frequency distribution of a photon count value at each gate shift position according to the present embodiment. FIG. 9 illustrates a frequency distribution (third frequency distribution) of the count value (photon count value) held in the counting unit 220 at each gate shift position.

As illustrated in FIG. 9, a high photon count value is obtained at a gate shift position sp4. This is because, at the gate shift position sp4, the holding unit 216a holds a 1-bit signal based on reflected light of first pulsed light, and the holding unit 216b holds a 1-bit signal based on reflected light of second pulsed light. Since the gate element 219 outputs a logical product of the 1-bit signals to the counting unit 220, the count value of the counting unit 220 is frequently counted up at the gate shift position sp4.

As illustrated in FIG. 9, the photon count value is relatively low except for at the gate shift position sp4 described above. This is because reflected light is not detected in at least one of the holding units 216a and 216b except for at the gate shift position sp4. Count values at positions other than the gate shift position sp4 are caused by slight incident light caused by disturbance light and noise occurring at a low frequency in an APD 211, and are not caused by reflected light from an object X.

As described above, a peak of the photon count value is detected at a gate shift position corresponding to a time of flight of two rays of pulsed light. Then, a ranging unit 41 can calculate a distance from a ranging device 1 to the object X based on the peak of the photon count value. Therefore, also in the present embodiment, the ranging device 1 capable of reducing deterioration in ranging accuracy caused by noise is provided.

Furthermore, in the present embodiment, the 1-bit signals held by the two holding units 216a and 216b are integrated by the gate element 219. Therefore, in the present embodiment, the amount of information output from a light receiving unit 20 to the ranging unit 41 can be reduced, and a data rate is reduced. Furthermore, in the present embodiment, narrowing of the peak in processing of extracting the gate shift position in steps S11 to S13 in a distance calculation method of FIG. 6 is performed in advance in the pixel 210. Therefore, in the present embodiment, the processing performed by the ranging unit 41 can be reduced, so that the ranging processing is simplified.

### Fourth Embodiment

In the present embodiment, a modification of the configuration of the pixel 210 according to the third embodiment will be described. In the present embodiment, a description of elements common to the first to third embodiments may be omitted or simplified.

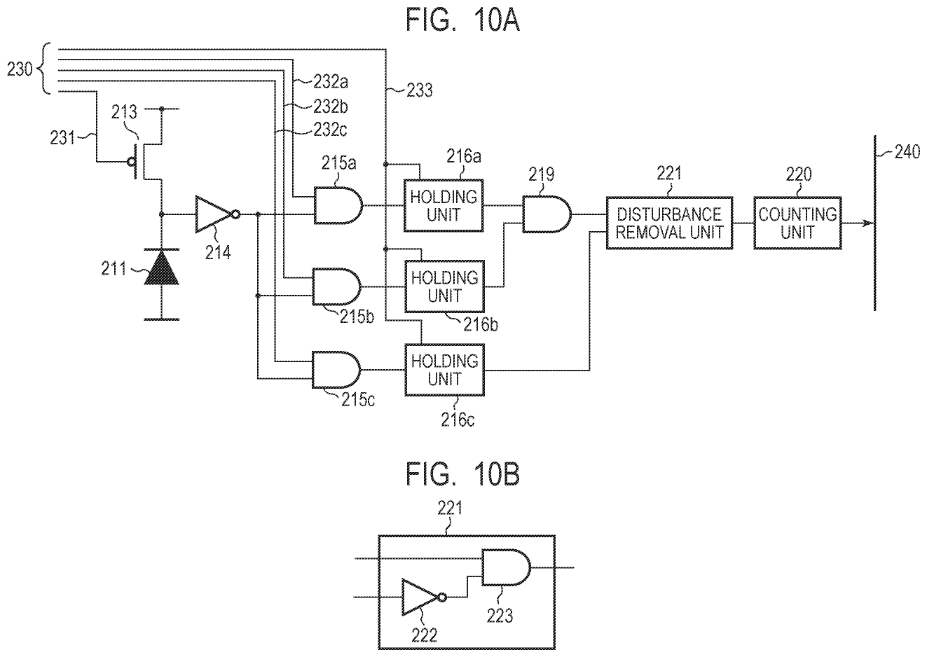

FIGS. 10A and 10B are block diagrams illustrating a configuration of a pixel 210 according to the present embodiment. As illustrated in FIG. 10A, in the pixel 210 according to the present embodiment, a gate element 215c, a holding unit 216c, and a disturbance removal unit 221 are arranged in addition to the configuration of the third embodiment. As illustrated in FIG. 10B, the disturbance removal unit 221 includes an inverter 222 and a gate element 223. FIG. 10B illustrates an example in which an AND circuit having two input terminals is used as the gate element 223.

The gate element 215c is a circuit that performs gating in such a way as to pass a pulse signal output from a waveform shaping unit 214 for a predetermined period. FIG. 10A illustrates an example in which an AND circuit having two input terminals is used as the gate element 215c. An output terminal of the waveform shaping unit 214 is further connected to a first input terminal of the gate element 215c. A pixel control signal line 232c is connected to a second input terminal of the gate element 215c. A control signal generation unit 22 supplies a gate signal Pgc to the gate element 215c via the pixel control signal line 232c.

The gate element 215c outputs a logical product of the gate signal Pgc and a signal input to the first input terminal to the holding unit 216c. As a result, the gate element 215c allows the signal input to the first input terminal to pass during a period in which the gate signal Pgc is at a high level. An exposure period (third period) in the gate element 215c can be set to a period different from any of exposure periods in gate elements 215a and 215b. The gate elements 215c only needs to implement gating, and may have a circuit configuration other than the AND circuit. In addition, the waveform shaping unit 214 and the gate element 215c may be integrated by using a logic circuit such as a NAND circuit.

In a case where a high-level pulse signal is input from the gate element 215c, the holding unit 216c (third holding unit) holds a 1-bit signal (high-level signal) indicating that the pulse signal is input. The 1-bit signal is a signal indicating that disturbance light is incident. A pixel control signal line 233 is connected to a reset terminal of the holding unit 216c, and a holding unit reset signal is supplied. The holding unit 216c is, for example, an RS-flip-flop.

An output terminal of the gate element 219 is connected to a first input terminal of the gate element 223. An output terminal of the holding unit 216c is connected to an input terminal of the inverter 222, and an output terminal of the inverter 222 is connected to a second input terminal of the gate element 223. An output terminal of the gate element 223 is connected to an input terminal of a counting unit 220. The disturbance removal unit 221 outputs a high-level signal to the counting unit 220 in a case where signals held by the holding unit 216a and the holding unit 216b are both at a high level and a signal held in the holding unit 216c is at a low level.

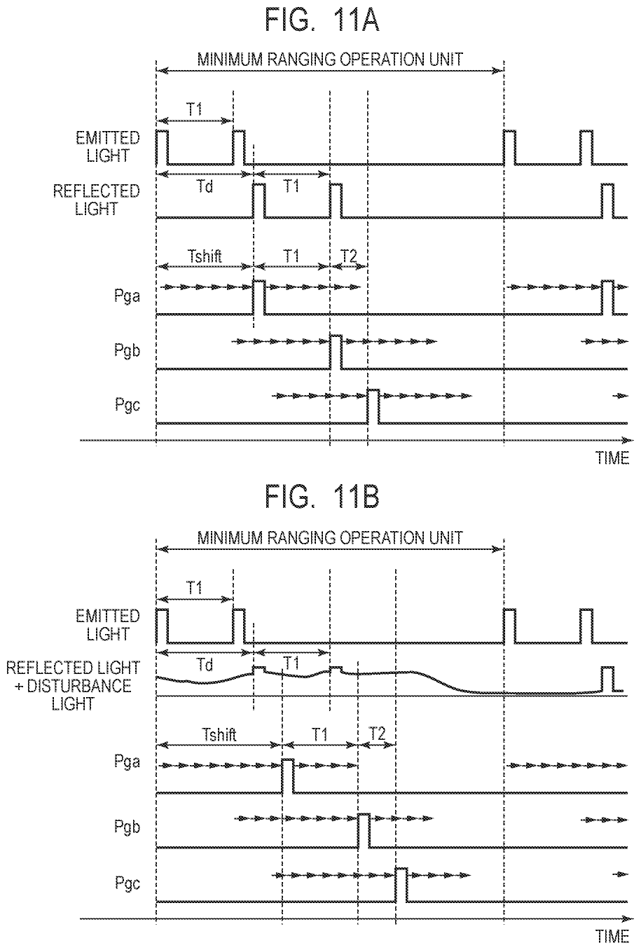

FIGS. 11A and 11B are timing diagrams illustrating timings of emitted light, reflected light, and a gate signal according to the present embodiment. In FIG. 11A, a difference from FIG. 4 is that “Pgc” indicating a timing of a level change of the gate signal Pgc is added. In the example of FIG. 11A, a period in which the gate signal Pgc is at a high level is later than a period in which a gate signal Pgb is at a high level by a time difference T2. However, the period in which the gate signal Pgc is at a high level is not limited thereto. For example, the period in which the gate signal Pgc is at a high level may be before the period in which the gate signal Pgb is at a high level, or may be before a period in which a gate signal Pga is at a high level.

The example illustrated in FIG. 11A illustrates the high-level periods of the gate signals Pga, Pgb, and Pgc in a case where a time of flight Td of light and a time difference Tshift become closest due to a gate shift. The high-level period of the gate signal Pga substantially coincides with a pulse of the first reflected light. Therefore, the holding unit 216a holds a high-level signal based on the first reflected light. The high-level period of the gate signal Pgb substantially coincides with a pulse of the second reflected light. Therefore, the holding unit 216b holds a high-level signal based on the second reflected light. The high-level period of the gate signal Pgc does not coincide with a pulse of the reflected light. Therefore, the holding unit 216c holds a low-level signal. At this time, the disturbance removal unit 221 outputs a high-level signal to the counting unit 220. Therefore, in the situation of FIG. 11A, the count value held in the counting unit 220 is counted up by 1.

The example illustrated in FIG. 11B illustrates the high-level periods of the gate signals Pga, Pgb, and Pgc in a situation where the time of flight Td of light and the time difference Tshift are different due to the gate shift, and light in which reflected light and disturbance light are mixed is incident on a light receiving unit 20. As illustrated in FIG. 11B, the disturbance light is incident on the light receiving unit 20 in any period of the gate signals Pga, Pgb, and Pgc. Therefore, a high-level signal is held in any of the holding units 216a, 216b, and 216c due to an influence of the disturbance light. At this time, the disturbance removal unit 221 outputs a low-level signal to the counting unit 220. Therefore, in the situation of FIG. 11B, the count value held in the counting unit 220 is not counted up.

As described above, in the present embodiment, a ranging device 1 that can obtain the same effects as those of the third embodiment is provided. Furthermore, in the present embodiment, when disturbance light is incident on the light receiving unit 20, the disturbance removal unit 221 performs control to deactivate output of signals from the holding units 216a and 216b, so that the photon count value of the counting unit 220 is not increased. As a result, the ranging device 1 capable of further reducing deterioration in ranging accuracy caused by disturbance light is provided.

### Fifth Embodiment

In the present embodiment, a modification of the configuration of the pixel 210 according to the fourth embodiment will be described. In the present embodiment, a description of elements common to the first to fourth embodiments may be omitted or simplified.

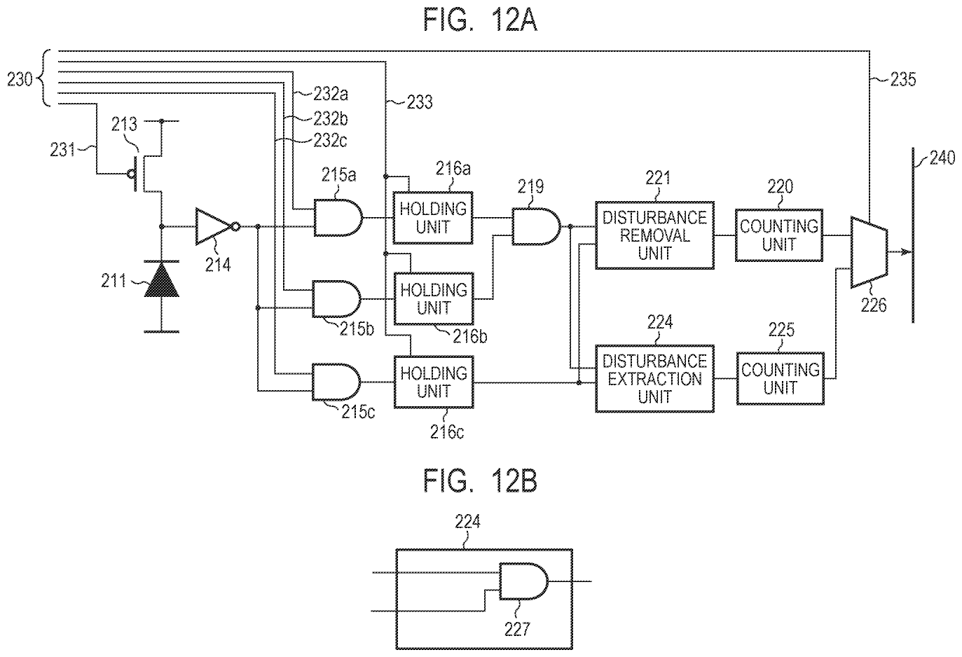

FIGS. 12A and 12B are block diagrams illustrating a configuration of a pixel 210 according to the present embodiment. As illustrated in FIG. 12A, in the pixel 210 according to the present embodiment, a disturbance extraction unit 224, a counting unit 225, and a selector element 226 are arranged in addition to the configuration of the fourth embodiment. As illustrated in FIG. 12B, the disturbance extraction unit 224 includes a gate element 227. FIG. 12B illustrates an example in which an AND circuit having two input terminals is used as the gate element 227.

An output terminal of a gate element 219 is connected to a first input terminal of the gate element 227. An output terminal of a holding unit 216c is connected to a second input terminal of the gate element 227. An output terminal of the gate element 227 is connected to an input terminal of the counting unit 225. The disturbance extraction unit 224 outputs a high-level signal to the counting unit 225 in a case where signals held in a holding unit 216a and a holding unit 216b are both at a high level and a signal held in the holding unit 216c is also at a high level. The counting unit 225 (fourth counting unit) is a counter that stores a multi-bit digital signal (count value) to be counted up according to an edge of an output signal of the disturbance extraction unit 224.

Output terminals of a counting unit 220 and the counting unit 225 are connected to two input terminals of the selector element 226. A pixel control signal line 235 is connected to a control terminal of the selector element 226. A control signal generation unit 22 supplies a selection signal to the selector element 226 via the pixel control signal line 235. The selector element 226 sequentially connects the two input terminals to a signal line 240 according to the selection signal. As a result, the selector element 226 sequentially outputs signals held in the counting units 220 and 225 to the signal line 240.

Timings of emitted light, reflected light, and a gate signal in the present embodiment are similar to those in FIG. 11A or 11B. In the example illustrated in FIG. 11B, a high-level signal is held in any of the holding units 216a, 216b, and 216c under an influence of disturbance light. At this time, the disturbance extraction unit 224 outputs a high-level signal to the counting unit 225. Therefore, in the situation of FIG. 11B, the count value held in the counting unit 225 is counted up by 1.

The counting unit 225 is configured to count up the count value by 1 in a case where normal detection has not been performed due to disturbance light, that is, in a case where output of the signals from the holding units 216a and 216b is deactivated. As a result, a ranging unit 41 can acquire a count value indicating the number of times normal detection has failed due to disturbance light. The ranging unit 41 may control a timing control unit 40 to retry the same ranging operation in a case where the count value is larger than a predetermined threshold. In a case where the count value is large, there is a high possibility that normal ranging has not been performed, and thus, the ranging accuracy may be improved by performing the retry.

As described above, in the present embodiment, the ranging device 1 that can obtain the same effects as those of the fourth embodiment is provided. Furthermore, in the present embodiment, it is possible to acquire a count value indicating the number of times normal detection has failed due to disturbance light. The count value can be used for improving the ranging accuracy by retrying the ranging operation or the like.

### Sixth Embodiment

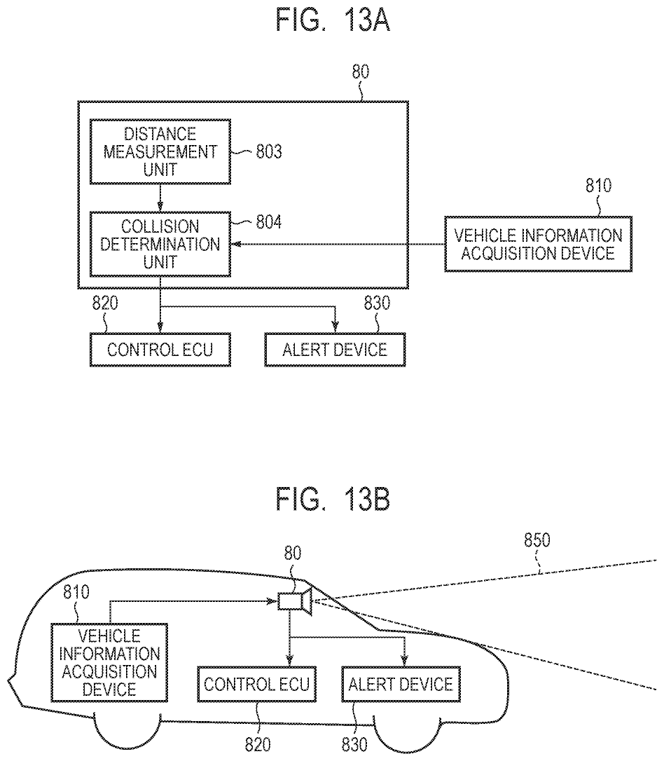

FIGS. 13A and 13B are block diagrams of equipment relating to an in-vehicle ranging device according to the present embodiment. Equipment 80 includes a distance measurement unit 803, which is an example of the ranging device 1 of the above-described embodiments, and a signal processing device (processing device) that processes a signal from the distance measurement unit 803. The equipment 80 includes the distance measurement unit 803 that measures a distance to an object, and a collision determination unit 804 that determines whether or not there is a possibility of collision based on the measured distance. The distance measurement unit 803 is an example of a distance information acquisition unit that obtains distance information to the object. That is, the distance information is information on a distance to the object or the like. The collision determination unit 804 may determine the collision possibility using the distance information.

The equipment 80 is connected to a vehicle information acquisition device 810, and can obtain vehicle information such as a vehicle speed, a yaw rate, and a steering angle. Further, the equipment 80 is connected to a control ECU 820 which is a control device that outputs a control signal for generating a braking force to the vehicle based on the determination result of the collision determination unit 804. The equipment 80 is also connected to an alert device 830 that issues an alert to the driver based on the determination result of the collision determination unit 804. For example, when the collision possibility is high as the determination result of the collision determination unit 804, the control ECU 820 performs vehicle control to avoid collision or reduce damage by braking, returning an accelerator, suppressing engine output, or the like. The alert device 830 alerts the user by sounding an alarm, displaying alert information on a screen of a car navigation system or the like, or giving vibration to a seat belt or a steering wheel. These devices of the equipment 80 function as a movable body control unit that controls the operation of controlling the vehicle as described above.

In the present embodiment, ranging is performed in an area around the vehicle, for example, a front area or a rear area, by the equipment 80. FIG. 13B illustrates equipment when ranging is performed in the front area of the vehicle (ranging area 850). The vehicle information acquisition device 810 as a ranging control unit sends an instruction to the equipment 80 or the distance measurement unit 803 to perform the ranging operation. With such a configuration, the accuracy of distance measurement can be further improved.

Although the example of control for avoiding a collision to another vehicle has been described above, the embodiment is applicable to automatic driving control for following another vehicle, automatic driving control for not going out of a traffic lane, or the like. Furthermore, the equipment is not limited to a vehicle such as an automobile and can be applied to a movable body (movable apparatus) such as a ship, an airplane, a satellite, an industrial robot and a consumer use robot, or the like, for example. In addition, the equipment can be widely applied to equipment which utilizes object recognition or biometric authentication, such as an intelligent transportation system (ITS), a surveillance system, or the like without being limited to movable bodies.

### Modified Embodiments

The present disclosure is not limited to the above embodiments, and various modifications are possible. For example, an example in which some of the configurations of any one of the embodiments are added to other embodiments and an example in which some of the configurations of any one of the embodiments are replaced with some of the configurations of other embodiments are also embodiments of the present invention.

The disclosure of this specification includes a complementary set of the concepts described in this specification. That is, for example, if a description of “A is B” (A=B) is provided in this specification, this specification is intended to disclose or suggest that “A is not B” even if a description of “A is not B” (A B) is omitted. This is because it is assumed that “A is not B” is considered when “A is B” is described.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

It should be noted that any of the embodiments described above is merely an example of an embodiment for carrying out the present invention, and the technical scope of the present invention should not be construed as being limited by the embodiments. That is, the present invention can be implemented in various forms without departing from the technical idea or the main features thereof.

According to the present disclosure, a ranging device capable of reducing deterioration in ranging accuracy caused by noise is provided.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-068362, filed Apr. 19, 2023, which is hereby incorporated by reference herein in its entirety.

What is claimed is:

1. A ranging device comprising:
a control unit configured to control a timing at which a light source device emits pulsed light;
a light receiving unit that includes a pixel configured to generate a signal indicating a presence or absence of incidence of light in some of a plurality of periods corresponding to a time from emission to reception of the pulsed light; and
a ranging unit configured to acquire information indicating a distance to an object based on a plurality of signals acquired while shifting a period in which signal generation is performed in the light receiving unit,
wherein the pixel includes a first holding unit configured to hold a signal indicating a presence or absence of incidence of the pulsed light on the pixel in a first period, and a second holding unit configured to hold a signal indicating a presence or absence of incidence of the pulsed light on the pixel in a second period different from the first period,
wherein the control unit performs control so that first pulsed light and second pulsed light are emitted at different times in one signal acquisition period,
wherein a time difference between the first period and the second period is set to correspond to a time difference between the first pulsed light and the second pulsed light, and
wherein the ranging unit performs ranging based on the signal held in the first holding unit and the signal held in the second holding unit.

2. The ranging device according to claim 1, wherein the ranging unit performs the ranging based on a first frequency distribution generated based on the signal held in the first holding unit and a second frequency distribution generated based on the signal held in the second holding unit.

3. The ranging device according to claim 2, wherein the pixel further includes a first counting unit configured to generate a frequency in the first frequency distribution by counting the signal held in the first holding unit, and a second counting unit configured to generate a frequency in the second frequency distribution by counting the signal held in the second holding unit.

4. The ranging device according to claim 2, wherein the ranging unit acquires the information indicating the distance to the object based on peaks in a common period among peaks of the frequencies in each of the first frequency distribution and the second frequency distribution.

5. The ranging device according to claim 2, wherein the ranging unit extracts a set of peaks having an interval corresponding to a time interval between the first pulsed light and the second pulsed light from a plurality of peaks of frequencies in each of the first frequency distribution and the second frequency distribution.

6. The ranging device according to claim 1, wherein the pixel further includes a logic circuit configured to output a logical product of the signal held in the first holding unit and the signal held in the second holding unit.

7. The ranging device according to claim 6, wherein the ranging unit performs the ranging based on a third frequency distribution generated based on a signal output from the logic circuit.

8. The ranging device according to claim 7, wherein the pixel further includes a third counting unit configured to generate a frequency in the third frequency distribution by counting the signal output from the logic circuit.

9. The ranging device according to claim 7, wherein the ranging unit acquires the information indicating the distance to the object based on a peak of a frequency in the third frequency distribution.

10. The ranging device according to claim 1, wherein the pixel further includes a third holding unit configured to hold a signal indicating a presence or absence of incidence of light on the pixel in a third period different from both the first period and the second period.

11. The ranging device according to claim 10, wherein, in a case where the signal held in the third holding unit indicates that light has been incident on the pixel, output of the signal held in the first holding unit and the signal held in the second holding unit is deactivated.

12. The ranging device according to claim 11, wherein the pixel further includes a fourth counting unit configured to count the number of times the deactivation has occurred.

13. The ranging device according to claim 12, wherein the ranging unit retries the ranging in a case where the number of times the deactivation has occurred counted by the fourth counting unit exceeds a predetermined threshold.

14. The ranging device according to claim 1, wherein each of the first holding unit and the second holding unit has a storage capacity for holding 1-bit information.

15. The ranging device according to claim 1, wherein the signals held in the first holding unit and the second holding unit are reset every time the one signal acquisition period elapses.

16. The ranging device according to claim 1, wherein the signals held in the first holding unit and the second holding unit are reset every time a plurality of the signal acquisition periods elapse.

17. The ranging device according to claim 1, wherein the pixel further includes an avalanche photodiode.

18. The ranging device according to claim 1, wherein the light receiving unit includes a plurality of the pixels arranged to form a plurality of rows and a plurality of columns.

19. Equipment comprising:
the ranging device according to claim 1; and
a processing device configured to process distance information acquired by the ranging device.

20. A movable body comprising:
the ranging device according to claim 1; and
a movable body control unit configured to control the movable body based on distance information acquired by the ranging device.
